(19) United States
(12) Patent Application Publication
(10) Pub. No.: US 2017/0193782 A1
(43) Pub. Date: Jul. 6, 2017

(54) PASSIVE INFRARED SYSTEMS AND METHODS THAT USE PATTERN RECOGNITION TO DISTINGUISH BETWEEN HUMAN OCCUPANTS AND PETS

(71) Applicant: Google Inc., Mountain View, CA (US)

(72) Inventors: Aveek Ravishekhar Purohit, Palo Alto, CA (US); Kenneth Louis Herman, Palo Alto, CA (US)

(21) Appl. No.: 14/985,119

(22) Filed: Dec. 30, 2015

(51) Int. Cl. G08B 13/24; G01J 5/02; G01J 5/00

(52) U.S. Cl. CPC G08B 13/2494; G01J 5/0025; G01J 5/025

(57) ABSTRACT

Systems and methods that use pattern recognition to characterize stimuli captured by passive infrared motion sensors are provided. The pattern recognition can be performed by comparing one or more features extracted from motion sensor data to known features. This provides enhanced pet rejection that exceeds performance of conventional threshold based pet rejecting PIR systems. In some embodiments, the known features can be obtained through simulations that accurately model the performance of motion sensors and their response to a large variety of stimuli. The simulations result in an extensive database that can be accessed by motion sensor units when performing pattern matching algorithms to determine whether the stimulus is a human or a pet.

### TECHNICAL FIELD

This patent specification relates to motion sensors, and in particular to passive infrared motion sensors.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Several types of passive infra-red sensors have been described in the prior art for detecting occupancy of human occupants in an area of interest, such as a home or office. Such sensors detect the changes in the infra-red radiation falling on an infra-red detector caused by movement of the infra-red emitting intruder in the field of view of the sensor. The area under surveillance is focused onto the infra-red sensitive detector by an array of lenses that produce a number of discrete zones. As the occupant crosses from zone to zone, the changes in the detector output above the ambient level from the surroundings are amplified by suitable circuitry, and an alarm signal is generated.

Detector effectiveness often is improved with optics that include segmented mirrors or lenses having multiple fields-of-view. Movement of an infra-red target into or through any of the fields will produce an electrical signal at the sensor, increasing the probability of detection. A detector mounted six or seven feet high in the corner of a room, for example, may have twenty or more separate fields-of-view, sometimes called zones, covering the room both horizontally and vertically. Fields-of-view that intercept the floor will detect or “catch” intruders attempting to crawl into the protected region. At the same time, however, they also catch ground based domestic animals, such as dogs and cats. Since household pets are likely to produce false alarms whenever they are active in the protected area, detectors often are disarmed, or the pets are confined to areas not protected by the system. This causes a dilemma in households where pets that might otherwise deter intruders instead reduce system effectiveness.

Accordingly, what is needed are systems and methods for accurately distinguishing between human occupants and pets.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Systems and methods that use pattern recognition to characterize stimuli captured by passive infrared motion sensors are provided. The pattern recognition can be performed by comparing one or more features extracted from motion sensor signals to known features, thereby providing enhanced pet rejection that exceeds performance of conventional threshold based pet rejecting PIR systems. In some embodiments, the known features can be obtained through simulations that accurately model the performance of motion sensors and their response to a large variety of stimuli. The simulations result in an extensive database that can be accessed by motion sensor units when performing pattern matching algorithms to determine whether the stimulus is a human or a pet.

### INSERT INDEPENDENT CLAIMS AFTER FIRST DRAFT APPROVED

Various refinements of the features noted above may be used in relation to various aspects of the present disclosure. Further features may also be incorporated in these various aspects as well. These refinements and additional features may be used individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

A further understanding of the nature and advantages of the embodiments discussed herein may be realized by reference to the remaining portions of the specification and the drawings.

### BRIEF DESCRIPTION OF THE DRAWINGS

FIG. 1 shows illustrative motion detection system according to an embodiment;

FIG. 2 shows an illustrative side view of the motion detector's field of view, according to an embodiment;

FIG. 3 shows an illustrative front view of the motion detector's field of view, according to an embodiment;

FIG. 4 shows an illustrative block diagram of a simulator, according to an embodiment;

FIGS. 5A and 5B shows illustrative feature waveforms of humans and pets, according to an embodiment;

FIG. 6 shows an illustrative schematic diagram of motion detection evaluation system, according to an embodiment;

FIG. 7 shows an illustrative process according to an embodiment; and

FIG. 8 shows a special-purpose computer system, according to an embodiment.

### DETAILED DESCRIPTION OF THE DISCLOSURE

In the following detailed description, for purposes of explanation, numerous specific details are set forth to provide a thorough understanding of the various embodiments. Those of ordinary skill in the art will realize that these various embodiments are illustrative only and are not intended to be limiting in any way. Other embodiments will readily suggest themselves to such skilled persons having the benefit of this disclosure.

In addition, for clarity purposes, not all of the routine features of the embodiments described herein are shown or described. One of ordinary skill in the art would readily appreciate that in the development of any such actual embodiment, numerous embodiment-specific decisions may be required to achieve specific design objectives. These design objectives will vary from one embodiment to another and from one developer to another. Moreover, it will be appreciated that such a development effort might be complex and time-consuming but would nevertheless be a routine engineering undertaking for those of ordinary skill in the art having the benefit of this disclosure.

It is to be appreciated that while one or more hazard detection embodiments are described further herein in the context of being used in a residential home, such as a single-family residential home, the scope of the present teachings is not so limited. More generally, hazard detection systems are applicable to a wide variety of enclosures such as, for example, duplexes, townhomes, multi-unit apartment buildings, hotels, retail stores, office buildings, and industrial buildings. Further, it is understood that while the terms user, customer, installer, homeowner, occupant, guest, tenant, landlord, repair person, and the like may be used to refer to the person or persons who are interacting with the hazard detector in the context of one or more scenarios described herein, these references are by no means to be considered as limiting the scope of the present teachings with respect to the person or persons who are performing such actions.

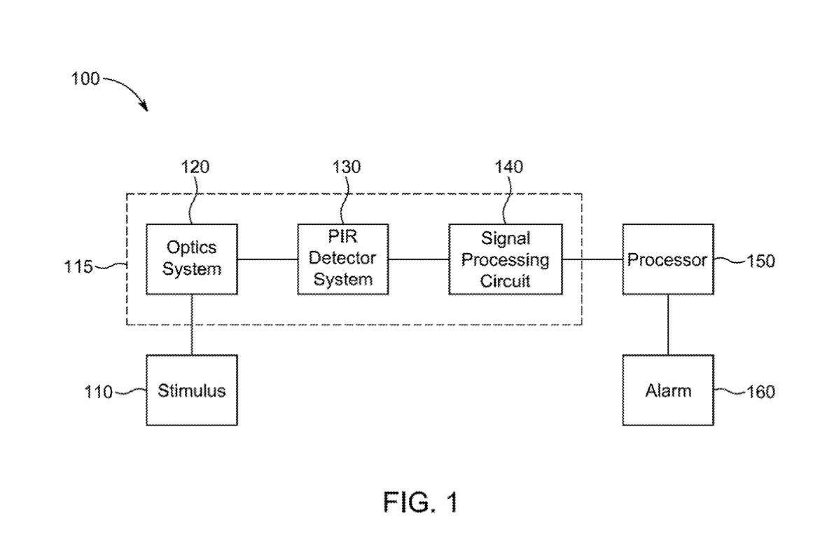

FIG. 1 shows illustrative motion detection system 100 according to an embodiment. System 100 is designed to detect movement of stimulus 110, such as a human occupant or pet. System 100 can include motion detection system 115, which can include optics system 120, passive infrared (PIR) detection system 130, and signal processing circuit 140. Optics system 120 that can include appropriate mirrors, lenses, mask, and other components known in the art for focusing images of stimulus 110 onto PIR detector system 130. In response to stimulus 110, PIR detector system 130 can generate a signal that can be filtered, amplified, and digitized by signal processing circuit 140, with processor 150 receiving the signal and determining whether to activate an audible or visual alarm 160 and/or notify a remote device (e.g., owner's phone) or service (e.g., police).

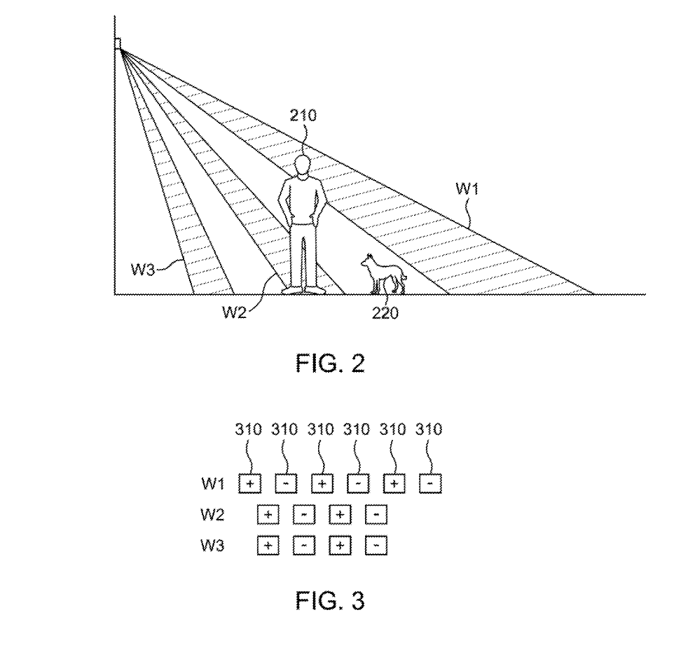

Optics system 120 and PIR detection system 130 can be specifically designed to achieve a desired field of view for motion detection system 115. That is, the field of view may be designed such that each of the zones defining the field of view is assigned a specific weight. For example, FIG. 2 shows an illustrative side view of the motion detector's field of view, according to an embodiment. As shown, the field of view has three different zones labeled, W1, W2, and W3, each of which may be assigned a specific weight. Different weights can be applied to each zone using a variety of different approaches. These approaches can include, for example, lens design, masking of the lens, and design of the sensors that detect infrared radiation. In one embodiment, the weighting of zone W1 may be greater than the weighting of zones W2 and W3, and the weighting of zones W2 and W3 may be different or the same. Use of different zone weightings may assist pattern matching algorithms according to embodiments discussed herein to differentiate between human occupants and pets. For example, human 210 (having a minimum height) may be simultaneously detected by two or more zones, whereas pet 220 may only be detected by one zone. Since human occupant 210 is likely to be detected by zone W1 more often than pet 220, zone W1 may be weighted more heavily than zones W2 and W3. The weighting pattern W1, W2, W3, and other weights of optical system 120 can be determined using a simulator. Exhaustive simulations such as monte carlo simulations can be performed for different configurations—optical zone weights (W) and pattern matching algorithms, to find the system with highest discrimination between pets and humans.

FIG. 3 shows an illustrative front view of the motion detector's field of view, according to an embodiment. PIR sensing elements 310 are arranged throughout the PIR detection system. As shown, PIR sensing elements 310 are arranged in three rows (or bands), labeled in accordance with its zones, W1, W2, and W3. As illustrated, zone W1 has 6 sensing elements, whereas zones W2 and W3 each have 4 sensing elements, thereby showing that zone W1 is weighted more heavily than zones W2 and W3. It should be appreciated that each zone may have an equal number of sensing elements, but the lens design or masking may affect the weighting specified for each zone. It should be further appreciated that any number of zones may exist for a motion detection sensor and that the embodiments discussed herein are not limited to three zones. It should also be further appreciated that the field of view, when viewed from a top view, may sweep anywhere between 0 and 180 degrees.

The zones and the weighting thereof discussed in FIGS. 2 and 3 are merely one example of a multitude of different hardware configurations for the optical system and PIR detection system. The hardware configurations, while important, represent one set of factors (e.g., hardware factors) taken into account by embodiments discussed herein to differentiate between human occupants and pets. Another set of factors taken into account are stimulus factors. These factors represent data associated with the stimuli being captured by the motion detector system. The processing of this data, and the results determined from the processing can dictate whether an alarm should be sounded or not. Because the hardware and stimulus factors can vary significantly, the relatively simple threshold comparison test performed by conventional prior art motion detection sensors often suffer from false positives. This is typically because the threshold comparison tests are unable to account for all the potential differences in the hardware and/or stimulus factors. Embodiments discussed herein markedly improve on conventional threshold comparison tests by pattern matching features extracted from motion sensor data with simulation based features.

The simulation based features can be obtained through simulations that use a particular hardware configuration and a multitude of stimulus factors. The hardware configuration can be an actual motion detector, or it may be a software representation of a motion detector. Thus, for any given hardware arrangement of the motion detector system, that particular arrangement can be subjected to a battery of stimuli to generate simulation based features. These simulation based features may form a basis for performing pattern matching with features extracted from motion sensor data. A database of simulation based features can be created for any number of different hardware configurations. The appropriate simulation based features may be stored in motion detection sensors that most closely resemble the hardware configuration, such that those simulation based features can be used for pattern matching.

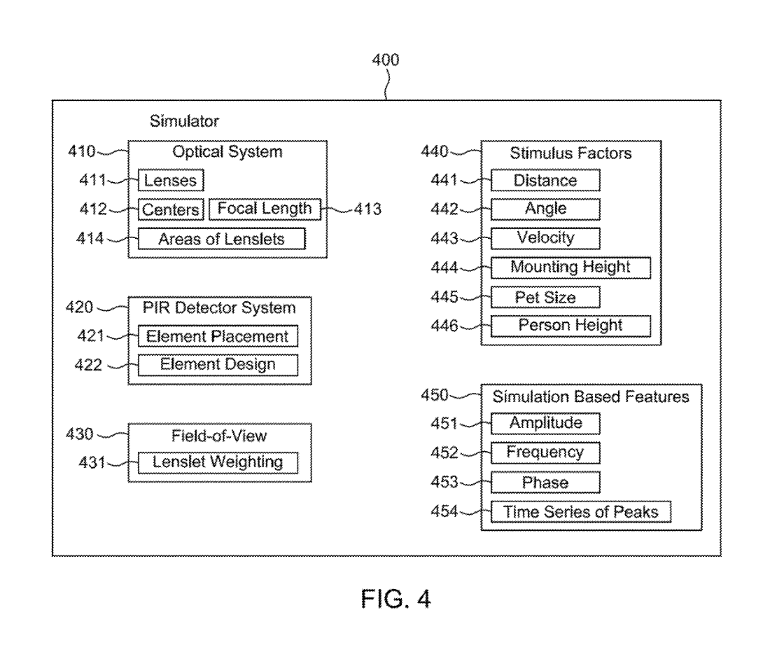

FIG. 4 shows an illustrative block diagram of a simulator 400 according to an embodiment. Simulator 400 can include several modules, shown as optical system module 410, PIR detector system module 420, field-of-view module 430, stimulus factor module 440, and simulation based feature module 450. Optical system module 410 may be a digital representation an optical system of a motion detector system. Different components and design features of the optical system can be modeled as part of module 410. For example, lenses 411, centers 412, focal length 413, and areas of lenslets 414 may represent different components and design features of the optical system. These components may be modeled to represent actual physical manifestation of an optical system or can be simulated representations of a fictitious optical system (but one that could be constructed).

PIR detector system module 420 may be digital representation of a PIR detector system. Module may model element placement 421 and element design 422. Element placement 421 may refer to the number and position of elements. Element design 422 may refer to the construction of the element. For example, elements may be constructed to have different compositions, shapes, substrate layout, etc.

Field of view module 430 may be a digital representation of the motion sensor's field of view. In one embodiment, the digital representation of the field of view may be the product of modules 410 and 420. In another embodiment, the field of view may take into account any masking that may have been applied to the optical system. Module 430 may model lenslet weighting 431 to provide an accurate digital representation of a motion detector system.

Stimulus factor module 440 may represent different factors related to stimuli that may be captured by a motion detector. Stimulus factors can include, for example, distance 441, angle 442, velocity 443, mounting height 444, pet size 445, and person height 446. Distance 441, angle 442, and velocity 443 may refer to different characteristic involving movement of a stimuli within the zones of the motion sensor. Mounting height 444 may refer to the position of the motion sensor on a wall or ceiling. For example, a motion sensor positioned at nine feet (relative to the floor) will capture stimuli differently than a motion sensor mounted at seven feet. Pet size 445 may refer to the size of a pet. For example, pets can be classified in different sizes such as small (e.g., 20 pounds), medium (e.g., 40 pounds), and large (e.g., 70 pounds). Person height 446 may, as its label implies, refers to the height of a human occupant. For example, a human occupant can be modeled to have certain minimum height (e.g., four feet, 10 inches). If desired, humans of multiple heights may be modeled.

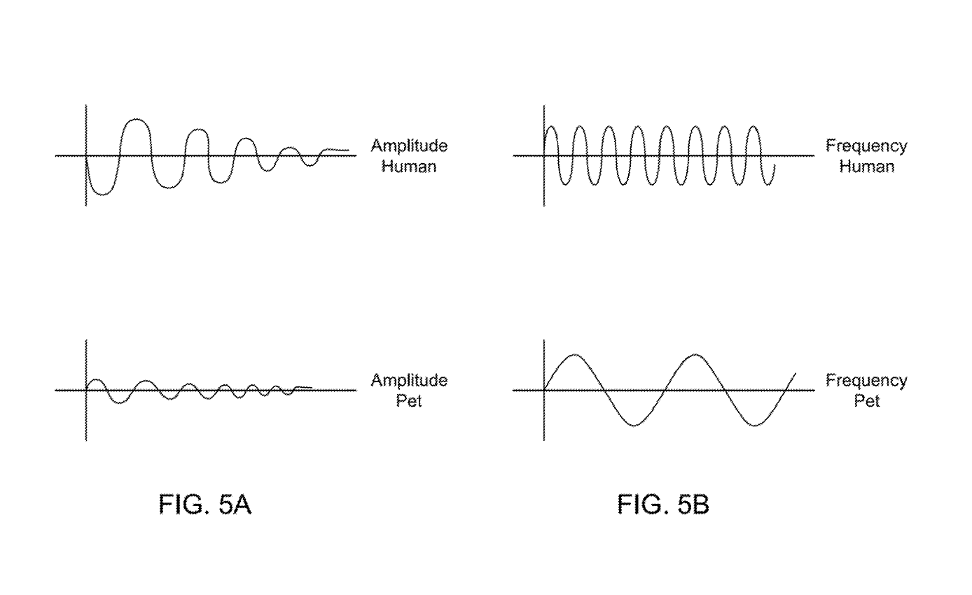

Simulation based features module 450 may include different simulated features obtained using a combination of modules 410, 420, 430, and 440. The simulated features can include any number of raw data extractions and/or statistical interpretations of the raw data. Four illustrative features are shown in module 450. These include amplitude 451, frequency 452, phase 453, and time series of peaks 454. Amplitude 451 may refer to the magnitude of a signal provided by a motion sensor. Referring briefly to FIG. 5A, which shows illustrative amplitude signals of a human and a pet, respectively, the magnitude of the human may be greater than that of a pet. This may be because the human occupies more zones than a pet and thus generates a larger magnitude response. The difference can be captured in the simulated based features and used for pattern matching with field data obtained from a motion sensor.

Frequency 452 may refer to the rate at which a stimulus crosses from zone to zone. Referring briefly to FIG. 5B, which shows illustrative frequency responses of a human and a pet, the frequency response of the human is faster than that of the pet. The differences in frequency response can be captured in the simulated based features and used for pattern matching with field data obtained from a motion sensor. Phase 453 may be used to infer the direction of the simulus' movement across the zones. Time series of peaks 454 may refer to a “window” analysis of peaks within the motion sensor data. The analysis of the peaks may be indicative of whether the stimulus is a human or pet.

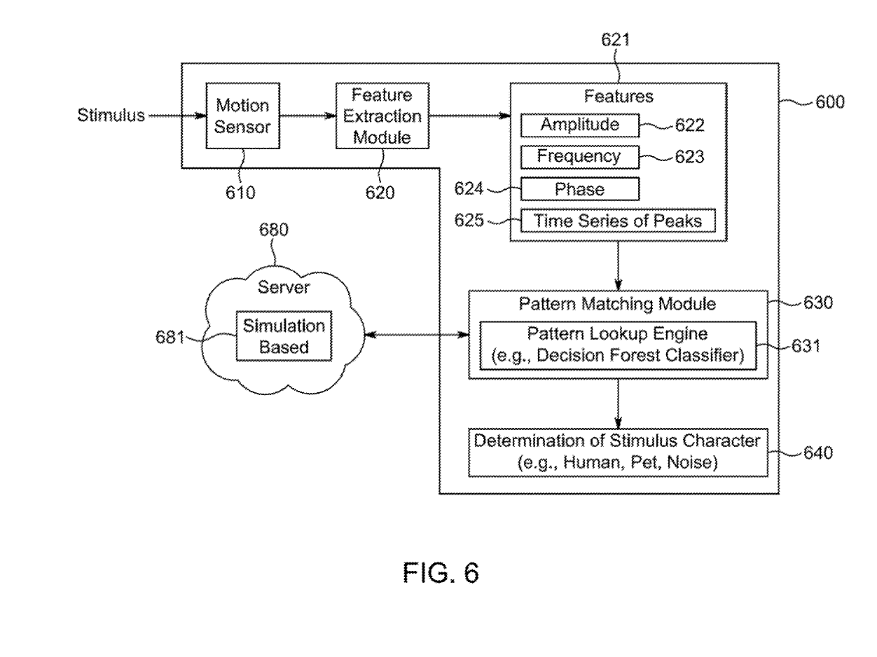

FIG. 6 shows an illustrative schematic diagram of motion detection evaluation system 600, according to an embodiment. System 600 can include motion sensor 610, feature extraction module 620, and pattern matching module 630. Motion sensor 610 can monitor for the presence of a stimulus and provide sensor data to feature extraction module 620 in response to monitoring the stimulus. Feature extraction module 620 may be implemented by a digital signal processor that extracts features 621 from the motion detector data. Features 621 can include amplitude 622, frequency 623, phase 624, and time series of peaks 625. One or more of features 621 are provided to pattern matching module 630, which can perform pattern matching to determine a character of the stimulus 640 (e.g., whether the stimulus most resembles a human, pet, or noise). Based on the determination of the stimulus 640, system 600 can sound an alarm or notify a remote service (e.g., police).

Pattern matching module 630 may access a pattern lookup engine 631 when attempting to match extracted features to simulation based features so that it produce a stimulus character determination 640. Pattern lookup engine 631 may be implemented as a decision forest classifier. The decision forest classifier is one example of pattern matching that may be implemented. Other suitable pattern matching techniques may be used by pattern lookup engine 631. The simulation based patterns may be stored in a local memory (not shown) that may be updated when system 600 receives updates from server 680. Server 680 may pass simulation based patterns 681 (e.g., obtained from simulator 400) to system 600 as part of a regular or systematic update process.

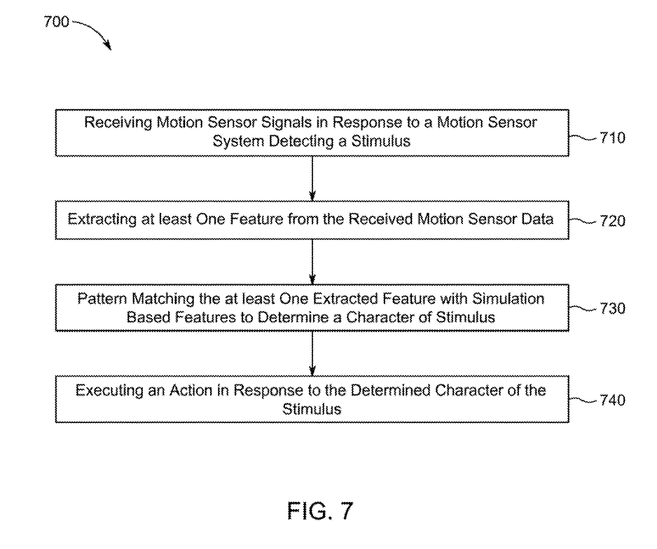

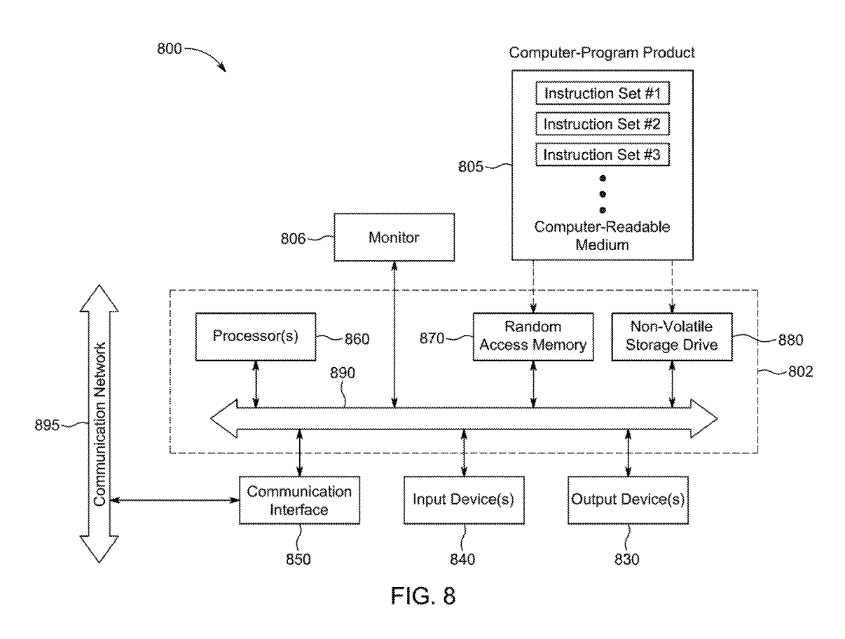

FIG. 7 shows an illustrative process 700 according to an embodiment. Process 700 begins at step 710, where motion sensor signals are received in response to a motion sensor system detecting a stimulus. For example, a motion detection system having a field of view similar to that as shown in FIG. 3. When a stimulus wanders into the system's field of view, signals are generated in response thereto. The signals are processed such that at least one feature is extracted, as indicated by step 720. For example, digital signal processing may be applied to extract at least one of amplitude, frequency, phase, and time series of peaks from the motion sensor signal.

At step 730, the at least one extracted feature is pattern matched with simulation based features to determine a character of the stimulus. The simulation based features may have been previously obtained via a simulator such as simulator 400. In one embodiment, the simulation based features can be generated based on a plurality of stimulus factors and a software representation of the motion sensor system. For example, the motion sensor system may be embodied by one or more of optical system 410, PIR detector system 420, and field-of-view 430. The pattern matching can be performed using, for example, a pattern lookup engine or a decision forest classifier.

At step 740, an action can be executed in response to the determined character of the stimulus. In one embodiment, the action can include activating an alarm and/or alerting a remote service when the determined character of the stimulus is a human. In another embodiment, the action can include not activating an alarm when the determined character of the stimulus is a pet. If desired, the action can include notifying an owner that his or her pet is moving around the house.

It should be appreciated that the steps in FIG. 7 are merely illustrative and that additional steps may be added, and that steps may be omitted, and the order of the steps may be re-arranged.

With reference to FIG. 8, an embodiment of a special-purpose computer system 800 is shown. For example, one or more intelligent components may be a special-purpose computer system 800. Such a special-purpose computer system 800 may be incorporated as part of a motion detector system and/or any of the other computerized devices discussed herein, such as a security system. The above methods may be implemented by computer-program products that direct a computer system to perform the actions of the above-described methods and components. Each such computer-program product may comprise sets of instructions (codes) embodied on a computer-readable medium that direct the processor of a computer system to perform corresponding actions. The instructions may be configured to run in sequential order, or in parallel (such as under different processing threads), or in a combination thereof. After loading the computer-program products on a general purpose computer system 800, it is transformed into the special-purpose computer system 800.

Special-purpose computer system 800 can include computer 802, a monitor 806 coupled to computer 802, one or more additional user output devices 830 (optional) coupled to computer 802, one or more user input devices 840 (e.g., keyboard, mouse, track ball, touch screen) coupled to computer 802, an optional communications interface 850 coupled to computer 802, a computer-program product 805 stored in a tangible computer-readable memory in computer 802. Computer-program product 805 directs computer system 800 to perform the above-described methods. Computer 802 may include one or more processors 860 that communicate with a number of peripheral devices via a bus subsystem 890. These peripheral devices may include user output device(s) 830, user input device(s) 840, communications interface 850, and a storage subsystem, such as random access memory (RAM) 870 and non-volatile storage drive 880 (e.g., disk drive, optical drive, solid state drive), which are forms of tangible computer-readable memory.

Computer-program product 805 may be stored in non-volatile storage drive 880 or another computer-readable medium accessible to computer 802 and loaded into random access memory (RAM) 870. Each processor 860 may comprise a microprocessor, such as a microprocessor from Intel® or Advanced Micro Devices, Inc.®, or the like. To support computer-program product 805, the computer 802 runs an operating system that handles the communications of computer-program product 805 with the above-noted components, as well as the communications between the above-noted components in support of the computer-program product 805. Exemplary operating systems include Windows® or the like from Microsoft Corporation, Solaris® from Sun Microsystems, LINUX, UNIX, and the like.

User input devices 840 include all possible types of devices and mechanisms to input information to computer 802. These may include a keyboard, a keypad, a mouse, a scanner, a digital drawing pad, a touch screen incorporated into the display, audio input devices such as voice recognition systems, microphones, and other types of input devices. In various embodiments, user input devices 840 are typically embodied as a computer mouse, a trackball, a track pad, a joystick, wireless remote, a drawing tablet, a voice command system. User input devices 840 typically allow a user to select objects, icons, text and the like that appear on the monitor 806 via a command such as a click of a button or the like. User output devices 830 include all possible types of devices and mechanisms to output information from computer 802. These may include a display (e.g., monitor 806), printers, non-visual displays such as audio output devices, etc.

Communications interface 850 provides an interface to other communication networks, such as communication network 895, and devices and may serve as an interface to receive data from and transmit data to other systems, WANs and/or the Internet. Embodiments of communications interface 850 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 850 may be coupled to a computer network, to a FireWire® bus, or the like. In other embodiments, communications interface 850 may be physically integrated on the motherboard of computer 802, and/or may be a software program, or the like.

RAM 870 and non-volatile storage drive 880 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 870 and non-volatile storage drive 880 may be configured to store the basic programming and data constructs that provide the functionality of various embodiments of the present invention, as described above.

Software instruction sets that provide the functionality of the present invention may be stored in RAM 870 and non-volatile storage drive 880. These instruction sets or code may be executed by the processor(s) 860. RAM 870 and non-volatile storage drive 880 may also provide a repository to store data and data structures used in accordance with the present invention. RAM 870 and non-volatile storage drive 880 may include a number of memories including a main random access memory (RAM) to store instructions and data during program execution and a read-only memory (ROM) in which fixed instructions are stored. RAM 870 and non-volatile storage drive 880 may include a file storage subsystem providing persistent (non-volatile) storage of program and/or data files. RAM 870 and non-volatile storage drive 880 may also include removable storage systems, such as removable flash memory.

Bus subsystem 890 provides a mechanism to allow the various components and subsystems of computer 802 to communicate with each other as intended. Although bus subsystem 890 is shown schematically as a single bus, alternative embodiments of the bus subsystem may utilize multiple busses or communication paths within the computer 802.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

It is to be appreciated that while the described methods and systems for intuitive status signaling at opportune times for a hazard detector are particularly advantageous in view of the particular device context, in that hazard detectors represent important life safety devices, in that hazard detectors are likely to be placed in many rooms around the house, in that hazard detectors are likely to be well-positioned for viewing from many places in these rooms, including from near light switches, and in that hazard detectors will usually not have full on-device graphical user interfaces but can be outfitted quite readily with non-graphical but simple, visually appealing on-device user interface elements (e.g., a simple pressable button with shaped on-device lighting), and in further view of power limitations for the case of battery-only hazard detectors making it desirable for status communications using minimal amounts of electrical power, the scope of the present disclosure is not so limited. Rather, the described methods and systems for intuitive status signaling at opportune times are widely applicable to any of a variety of smart-home devices such as those described in relation to FIG. 15 supra and including, but not limited to, thermostats, environmental sensors, motion sensors, occupancy sensors, baby monitors, remote controllers, key fob remote controllers, smart-home hubs, security keypads, biometric access controllers, other security devices, cameras, microphones, speakers, time-of-flight based LED position/motion sensing arrays, doorbells, intercom devices, smart light switches, smart door locks, door sensors, window sensors, generic programmable wireless control buttons, lighting equipment including night lights and mood lighting, smart appliances, entertainment devices, home service robots, garage door openers, door openers, window shade controllers, other mechanical actuation devices, solar power arrays, outdoor pathway lighting, irrigation equipment, lawn care equipment, or other smart home devices. Although widely applicable for any of such smart-home devices, one or more of the described methods and systems become increasingly advantageous when applied in the context of devices that may have more limited on-device user interface capability (e.g., without graphical user interfaces), and/or having power limitations that make it desirable for status communications using minimal amounts of electrical power, while being located in relatively readily-viewable locations and/or well-traveled locations in the home. Having read this disclosure, one having skill in the art could apply the methods and systems of the present invention in the context of one or more of the above-described smart home devices. Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Any processes described with respect to FIGS. 1-8, as well as any other aspects of the invention, may each be implemented by software, but may also be implemented in hardware, firmware, or any combination of software, hardware, and firmware. They each may also be embodied as machine- or computer-readable code recorded on a machine- or computer-readable medium. The computer-readable medium may be any data storage device that can store data or instructions that can thereafter be read by a computer system. Examples of the computer-readable medium may include, but are not limited to, read-only memory, random-access memory, flash memory, CD-ROMs, DVDs, magnetic tape, and optical data storage devices. The computer-readable medium can also be distributed over network-coupled computer systems so that the computer readable code is stored and executed in a distributed fashion. For example, the computer-readable medium may be communicated from one electronic subsystem or device to another electronic subsystem or device using any suitable communications protocol. The computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any or each module or state machine discussed herein may be provided as a software construct, firmware construct, one or more hardware components, or a combination thereof. For example, any one or more of the state machines or modules may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules or state machines are merely illustrative, and that the number, configuration, functionality, and interconnection of existing modules may be modified or omitted, additional modules may be added, and the interconnection of certain modules may be altered.

Whereas many alterations and modifications of the present invention will no doubt become apparent to a person of ordinary skill in the art after having read the foregoing description, it is to be understood that the particular embodiments shown and described by way of illustration are in no way intended to be considered limiting. Therefore, reference to the details of the preferred embodiments is not intended to limit their scope.

What is claimed is:

1. A motion detection evaluation system, comprising:
a motion sensor operative to produce motion sensor signals in response to monitored stimuli; and
a processor coupled to receive the motion sensor signals, the processor operative to:
extract at least one feature from the received motion sensor signals;
pattern match the at least one extracted feature with simulation based features to determine a character of the stimulus; and
execute an action in response to the determined character of the stimulus.

2. The motion detection evaluation system of claim 1, wherein the processor is operative to use a pattern lookup engine to determine the character of the stimulus.

3. The motion detection evaluation system of claim 2, wherein the pattern lookup engine is a decision forest classifier.

4. The motion detection evaluation system of claim 1, wherein the at least one extracted feature comprises at least one of amplitude, frequency, phase, and time series of peaks.

5. The motion detection evaluation system of claim 4, wherein the simulation based features comprise at least one of amplitude, frequency, phase, and time series of peaks based on computer simulations.

6. The motion detection evaluation system of claim 1, wherein the character of the stimulus is selected from a human, a pet, and noise.

7. The motion detection evaluation system of claim 6, wherein when the determined stimulus is the human, the executed action comprises activating an alarm.

8. The motion detection evaluation system of claim 1, wherein the simulation based features are generated based on a plurality of stimulus factors and a software representation of the motion sensor system.

9. A method for evaluating motion sensor data, comprising:
receiving motion sensor signals in response to a motion sensor system detecting a stimulus;
extracting at least one feature from the received motion sensor data;
pattern matching the at least one extracted feature with simulation based features to determine a character of the stimulus: and
executing an action in response to the determined character of the stimulus.

10. The method of claim 9, wherein the simulation based features are generated based on a plurality of stimulus factors and a software representation of the motion sensor system.

11. The method of claim 9, wherein the at least one extracted feature and the simulation based features each comprises at least one of amplitude, frequency, phase, and time series of peaks.

12. The method of claim 9, wherein the executing the action comprises activating an alarm when the determined character of the stimulus is a human.

13. The method of claim 9, wherein the executing the action comprises non activating an alarm when the determined character of the stimulus is a pet.

14. A system, comprising:
a motion sensor comprising a masked optical lens and a passive infrared (PIR) sensor, wherein the motion sensor comprises a plurality of power zones each having a different intensity, wherein the PIR sensor produces a signal in response to a stimulus detected within at least one of the power zones; and
a processor coupled to the motion sensor and operative to:
receive the signal from the motion sensor; and
compare the received signal to a plurality of known patterns to determine a character of the stimulus.

15. The system of claim 14, wherein the character of the stimulus is characterized as one of a human, a pet, and noise.

16. The system of claim 14, wherein the intensities of the power zones are selected to enable the PIR sensor to produce different signals in response to different stimuli detected within at least one of the power zones.

17. The system of claim 14, wherein the processor is operative to:
extract any one of a plurality of features from the received signal; and
use at least one of the extracted features to determine the character of the stimulus.

18. The system of claim 17, wherein the plurality of features comprises amplitude, frequency, phase, and time series of peaks.

19. The system of claim 14, further comprising:
storage coupled to the processor and operative to store a plurality of patterns;
wherein the processor is operative to use the plurality of patterns stored in the storage when determining the character of the stimulus.

20. The system of claim 14, wherein the masked optical lens is a Fresnel lens having a diameter less than two inches.
